(19) United States
(12) Patent Application Publication
(10) Pub. No.: US 2007/0101751 A1
(43) Pub. Date: May 10, 2007

(54) Freezer pop containing at least one active agent

(76) Inventors: Jitendra Somani, Toronto (CA); Joseph Lee, Toronto (CA)

Correspondence Address: Karen G. Horowitz;Warner-Lambert Company LLC, 201 Tabor Road, Morris Plains, NJ, 07950, US

(21) Appl. No.: 11/643,186

(22) Filed: Dec. 20, 2006

Related U.S. Application Data
(63) Continuation of application No. 10/868,102, filed on Jun. 15, 2004.

(51) Int. Cl. A23G 9/00

(52) U.S. Cl. 62/342

(57) ABSTRACT

A freezer pop for storing a freezable liquid, the freezer pop having a packaging including a sealed chamber for storing the freezable liquid formed from at least one inner layer having a sealable edge portion composed of a sealable material and sealed at the edge portion; at least one outer layer composed of a tear and puncture resistant material having an outside surface; at least one intermediate layer which is in sealable contact with both the at least one inner and outer layers, such that all layers are sealable together to form the sealed chamber; and at least one moisture barrier layer in proximity to the outer layer for at least substantially preventing moisture from escaping the sealed chamber for an extended period of time.

This application claims the benefit under 35 U.S.C. § 120 of the earlier filing date of U.S. patent application Ser. No. 10/868,102, filed Jun. 15, 2004, which application is hereby incorporated by reference in its entirety.

The present invention relates to packaging for active agent-containing freezer pops, and more particularly to a moisture barrier-containing packaging for freezer pops containing an active agent which needs protection against moisture loss, such as a pharmaceutical, which substantially reduces or eliminates moisture loss in the packaged product.

### BACKGROUND OF THE INVENTION

Frozen ice products including “snowballs”, Italian ices, freezer pops and frozen fruit juices have long been popular treats among consumers especially during the warmer weather months. Frozen ice products of this type can be carried on sticks, in plastic tubes, or in wax coated paper containers. No utensils or plates are necessary. One popular frozen ice product in particular is the freezer pop, which has been a staple of summer treats form any years. The freezer pop can be purchased and consumed in either as a chilled liquid or as a frozen product. The freezer pop is simple and convenient to store and distribute, and less messy to consume than other kinds of frozen ice products.

The conventional freezer pop is generally packaged in a substantially tubular pouch formed from two plastic laminate films adhesively joined and sealed along the common edges thereof. The sealed plastic laminate films, in combination, define a central cavity for enclosing a freezable liquid. The freezable liquid typically contains a flavoring agent, a coloring agent and/or a sweetener. Freezer pop formulations are described in published European Patent Application EP 1 287 747 A2 published Mar. 5, 2003, incorporated herein by reference. To form the freezer pop, a freezable liquid is cooled to temperatures sufficiently low to freeze the liquid as the freezer pop takes the shape of the central cavity. Thereafter, the freezer pop can be dispensed from the packaging by first cutting off the top end of the pouch to form an opening. The consumer simply presses the bottom end of the pouch to slide the freezer pop out through the opening. Alternatively, the freezer pop can be consumed in the liquid form by simply drawing the freezable liquid through the opening in the packaging.

Since freezer pops are seasonal products and are usually kept in the freezer or on the shelves for relatively short periods of time at a time, extended shelf life is not required for such products. Typically, the packaging film used for conventional freezer pops is fairly pervious to moisture, which can result in significant moisture loss over an extended period of time. The amount of moisture loss can reach 20% to 30% or more. As indicated above, due to their seasonal nature, conventional freezer pops are not adversely affected by long-term moisture loss. Therefore, the packaging used in freezer pops is generally designed for storage over a relatively short period of time.

Recently, active agents including, pharmaceuticals, medicaments and nutritional agents and the like have been added to freezer pop formulations to provide a unique vehicle for dosing various active agents to patients including children. However, the packaging used to house freezer pops containing such active agents has been found to be inadequate. This is because conventional packaging allows excessive moisture loss over an extended period of time, and current laws regulating typical active agents such as pharmaceuticals generally require a shelf life of two years. The amount of moisture loss typically encountered in current packaging is considered unacceptable for freezer pops which contain controlled amounts and concentrations of active agents. Such moisture loss can adversely affect the taste, ingredient balance, consistency, quality perception, and efficacy of the product.

Accordingly, it would be desirable to develop a packaging for storing a freezable liquid containing an active agent, which greatly enhances the shelf life and quality of the product. It would be further desirable to develop a packaging for freezer pops, which significantly reduces or eliminates undesirable moisture loss that would otherwise adversely affect the taste, quality, ingredient balance, and efficacy of the product.

### SUMMARY OF THE INVENTION

The present invention relates generally to packaging for storing a freezable liquid containing an active agent so that the active agent may be administered through a freezer pop. The packaging of the present invention includes an arrangement of film layers including a moisture barrier, which substantially reduces or eliminates undesirable moisture loss, thereby enhancing the quality and storage life of the freezable liquid. In addition, the packaging of the present invention is designed to resist tears and punctures for enhanced child-proof safety.

In one aspect of the present invention, there is provided a packaging in the form of a freezer pop for storing a freezable liquid, the packaging comprising:

a sealed chamber for storing the freezable liquid formed from at least one inner layer having a sealable edge portion comprised of a sealable material and sealed at the edge portion;

at least one outer layer comprised of a tear and puncture resistant material having an outside surface;

at least one intermediate layer which is in sealable contact with both the at least one inner and outer layers, such that all layers are sealable together to form the sealed chamber; and

at least one moisture barrier layer in proximity to the outer layer for at least substantially preventing moisture from escaping the sealed chamber for an extended period of time.

### BRIEF DESCRIPTION OF THE DRAWINGS

The following drawings in which like reference characters indicate like parts are illustrative of embodiments of the invention and are not intended to limit the invention as encompassed by the claims forming part of the application.

FIG. 1 is a perspective view of a packaging containing a freezable liquid in one embodiment of the of the present invention;

FIG. 2 is an enlarged cross sectional view of the packaging along lines 2-2 of FIG. 1 in accordance with the present invention; and

FIG. 3 is a schematic cross-sectional view of a packaging illustrating the layers used to form the sealed chamber in accordance with one embodiment of the present invention.

### DETAILED DESCRIPTION OF THE INVENTION

As used herein, the term “freezer pop” refers to a consumable freezable liquid contained within a sealed chamber which may be opened by the consumer to ingest the freezable liquid when in liquid or frozen form. The size and shape of the sealed chamber may vary and is only limited by the practicality of producing a consumer product.

The term “active agent” refers to any one or more ingredients which may be incorporated into a freezer pop to provide a beneficial effect to the consumer upon ingesting the freezer pop. The active agent will typically be a therapeutic agent such as pharmaceuticals, medicaments, nutritional agents, vitamins, neutraceuticals and the like.

The present invention is directed generally to packaging for a freezer pop containing one or more active agents as defined herein. The packaging containing the freezer pop, can be placed in a freezer to freeze the liquid. The packaging of the present invention is also designed to provide sufficient tear and puncture resistance to provide adequate child safety features, while withstanding the effects normally encountered with freezing and thawing the freezable liquid. Furthermore, the packaging of the present invention includes a moisture barrier that significantly reduces or eliminates moisture loss from the freezable liquid, which would otherwise adversely affect the quality and storage life of the freezer pop and the active agent that may be contained therein. Accordingly, the packaging of the present invention provides excellent protection against moisture loss, thereby maintaining the taste, quality, ingredient balance and efficacy of the freezable liquid and particularly any active agents contained therein.

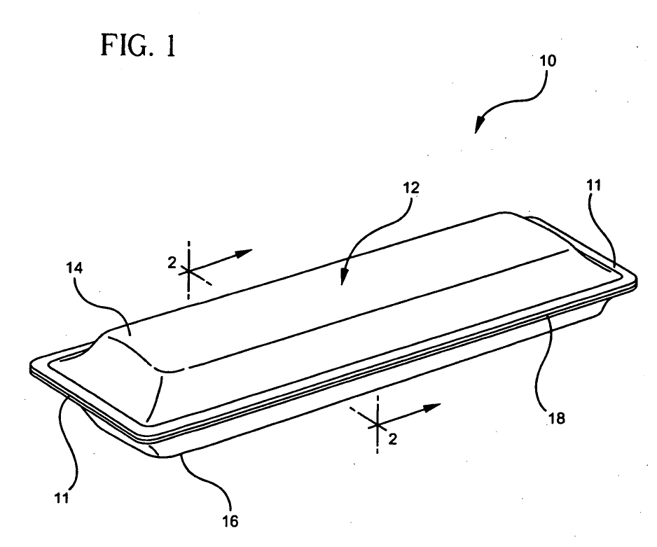

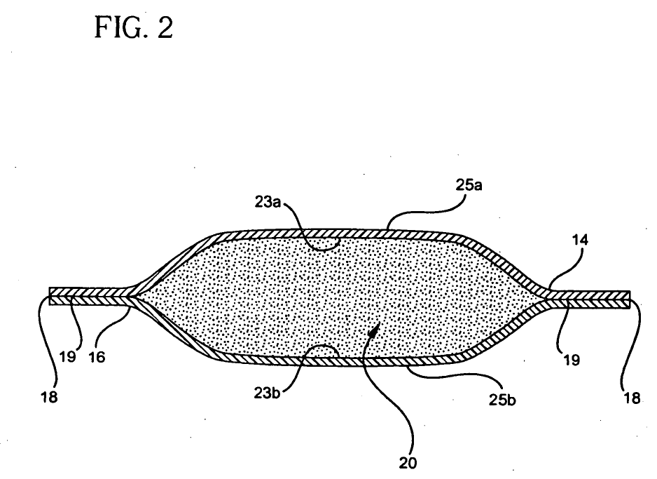

Referring to the drawings and first to FIG. 1, there is shown a packaging designed for enclosing a freezable liquid in the form of a freezer pop which may contain an active agent. The packaging identified generally by reference numeral 10 is shown having a substantially tubular body 12 with opposing ends 11. The tubular body 12 is formed from first and second films 14 and 16 positioned coextensively with one another. The first and second films 14 and 16 are each formed with a laminate construction of one or more layers of select materials as will be described hereinafter. The inner surfaces of the first and second films 14 and 16 are adapted to facilitate sealing of the films together through suitable sealing means along edge portions 18 thereof. The sealed first and second films 14 and 16 define a sealed chamber 20 (as best shown in FIG. 2) extending longitudinally through the tubular body 12.

The sealed chamber 20 is adapted to retain a quantity of the freezable liquid 22 which may contain one or more active agents (as best shown in FIG. 2) within the packaging 10. The first and second films 14 and 16 are made of select materials and are fabricated to resist tears and punctures, and withstand the effects normally associated with freezing and thawing of the freezable liquid 22.

The packaging 10 containing the freezable liquid 22 including one or more active agents may be placed in a freezer for a sufficient time to yield a freezer pop containing the active agent. Upon freezing, the freezer pop can be consumed by first opening one of the ends 11 of the tubular body 12, and thereafter exerting pressure from the opposed end to urge the frozen liquid out of the open end.

Referring to FIG. 2, the first and second films 14 and 16 are positioned so that opposing inner surfaces 23a and 23b face one another and thereby form an inner boundary of the sealed chamber 20 which encloses the freezable liquid 22. The edge portions 18 are maintained in sealing contact with one another at contact areas 19 through suitable sealing means as known in the art (e.g. an adhesive or through heat sealing). The outer surfaces 25a and 25b of the respective films 14 and 16 which form the exterior surface of the freezer pop and thereby do not contact the freezable liquid may be adapted to permit printing thereon. The printing, for example,may be required instructions for consuming a freezer pop, which contains an active agent. The first and second films 14 and 16may be transparent to enable the product to be visible to the consumer, if desired.

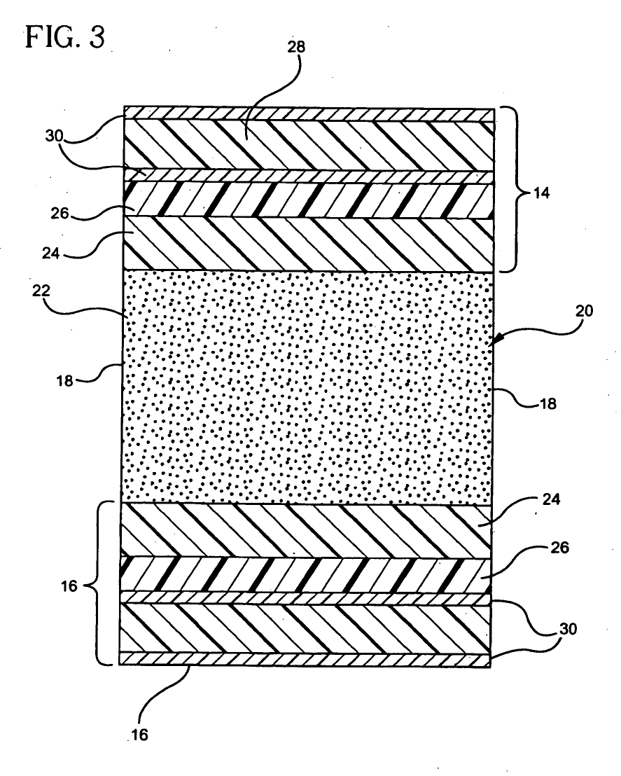

The arrangement and composition of the layers of material forming an embodiment of the packaging will now be explained with reference to FIG. 3. Referring to FIG. 3, there is shown the relative positioning of the first and second films 14 and 16 of the packaging 10 with the understanding that the dimensions of the different layers comprising first and second films 14 and 16 depicted herein are not drawn to scale or shown in proportion to one another. The first and second films 14 and 16 each include one or more discrete layers of polymer materials arranged to form the sealed chamber 20, which is occupied by the freezable liquid 22.

The first and second films 14 and 16 each include at least one adhesive layer 24 (a single layer is shown) in contact with the freezable liquid 22, one or more intermediate layers 26 (a single intermediate layer is shown) overlaying the adhesive layer 24, and at least one outer layer 28 (a single outer layer is shown) overlaying the intermediate layer 26.

The adhesive layers 24 form the base portion of the laminate film construction of the first and second films 14 and 16 and are the layers which are in direct contact with the freezable liquid through the respective bottom surfaces thereof. The adhesive layers 24 are sealingly engaged to one another along the edge portions 18 of the first and second films 14 and 16. The adhesive layer 24 may be composed of a suitable adhesive material, including, but not limited to, pressure sealable and/or heat sealable materials such as, for example, low-density polyethylene-linear low-density polyethylene (LDPE-LLDPE). The thickness of the adhesive layer 24 may typically range from about 100 gauge to 400 gauge. The selection of a suitable adhesive material may also provide tear and puncture resistant properties to the packaging. For example, LLDPE is known to exhibit both tear and puncture resistance.

One or more intermediate layers 26 overlay the outer surface of the adhesive layer 24. The intermediate layer 26 draws the adhesive layer 24 and the at least one outer layer 28 together into a single laminate structure, and forms a transition layer to provide a structural bond between the adhesive layer 24 and the outer layer 28 which contributes to providing a desirable child proof product which is both tear and puncture resistant. The intermediate layer 26 is typically composed of material such as low-density polyethylene (LDPE) and has a thickness generally from about 9 to 12 lbs/m², preferably about 10.8 lbs/m².

The at least one outer layer 28 forms the main structure of the laminate film 14 and 16, and overlays the outside surface of the intermediate layer 26. The outer layer 28 provides the laminate films 14 and 16 with the structural integrity necessary to provide the packaging 10 with the requisite tear and puncture resistance. The outer layer 28 provides the packaging with tear and puncture resistance sufficient to prevent children from accidentally gaining access to the freezable liquid. Tear and puncture resistance properties for this purpose would be known to those skilled in the art. The outer layer 28 is composed of a tear- and puncture-resistant material such as, for example, polyethylene terephthalate (PET), oriented polypropylene (OPP), and biaxial nylon. The thickness of the at least one outer layer 28 is typically of from about 36 gauge to 200 gauge, and preferably about 92 gauge.

The packaging 10 further includes at least one moisture barrier layer 30, which may be located between the intermediate layer 26 and the outer layer 28 and/or may overlay the outside surface of the outer layer 28. In the specific embodiment of FIG. 3, the moisture layer 30 is positioned in both locations for purposes of illustration. The moisture barrier layer 30 is selected from materials which are capable of providing sufficient moisture barrier properties to the packaging 10 so as to reduce moisture loss from the freezable liquid 22 for an extended period of time, typically up to or exceeding two years. The moisture barrier layer 30 provides the packaging with a water transmission rate of less than 0.25 gms/100 inch²/24 hours at 100° F., 90% RH.

The moisture barrier layer 30 may be selected from low moisture transmission materials including, for example, low moisture-transmission polymer films such as, for example, polyvinylidene chloride (PVDC), and polychlorotrifluoroethylene (PCTFE), coatings of silicon oxide and/or aluminum oxide and metal foils such as, for example, aluminum foil. The preferred low moisture transmission material is polyvinylidene chloride (PVDC). The moisture barrier layer is typically fabricated with a thickness of up to 2 gauge.

The packaging of the present invention is particularly suited to store freezable liquids containing one or more active agents, but may be employed for freezable liquids which do not contain an active agent. Suitable freezable liquid formulations in which an active agent may be added are disclosed in EP 1287747A2, as previously described.

The frozen liquid in the form of a freezer pop is preferably fast dissolving. The term “fast dissolving” as used herein means that the frozen liquid dissolves in less than 30 seconds, preferably less than 15 seconds, and more preferably less than 10 seconds, after placing the freezer pop in the oral cavity. To freeze the above-described freezable liquid, the packaging containing the freezable liquid is placed in a freezer at a temperature below 0° C., preferably from −5° C. to −20° C.

### EXAMPLE

A packaging for a freezer pop formulation containing dextromethorphan hydrobromide as an active agent is prepared by forming a packaging comprising two films sealed together to form a chamber for storing the freezer pop formulation.

The two films have the same or similar construction to that shown in FIG. 3. The adhesive layer is a low-density polyethylene-linear low-density polyethylene (LDPE-LLDPE) having a thickness of about 200 gauge. The intermediate layer is a low-density polyethylene (LDPE) having a thickness of about 10.8 lbs/m². The outer layer is polyethylene terphthalate coated with saran and has a thickness of about 50 gauge.

A moisture barrier layer of polyvinylidene chloride is provided on the outer surface of the outer layer and has a thickness of up to 2 gauge. The freezer pop formulation is stored in a holding tank and then passed through a plate heat exchanger for pasteurization. The pasteurized formulation is sent to a stainless steel feed tank. The formulation is loaded into the packaging in a conventional filling device. Such filling devices are commonly known in the art. It is preferred to use a device which is serviced by volumetric pumps. In the present instance the device is comprised of sets of eight bars on a single head feed line. The filing line is serviced by eight volumetric pumps—one for each filling line. The 8-bar set is vertically perforated so that an individual bars may be separated from the rest of the bars for administration.

What is claimed is:

1. A therapeutic freezer pop comprising:
a freezable consumable liquid containing a therapeutic agent formulated for oral consumption;
a packaging in the form of a substantially tubular body with opposing ends and a sealed chamber extending longitudinally therethrough storing said freezable consumable liquid, said sealed chamber being formed from at least one inner layer having a sealable edge portion comprised of a sealable material and sealed at the edge portion;
at least one outer layer comprised of a tear and puncture resistant material having an outside surface;
at least one intermediate layer which is in sealable contact with both said at least one inner and outer layers, such that all layers are sealable together to form said sealed chamber; and
at least one moisture barrier layer having a thickness of up to 2 gauge in proximity to said outer layer and at least substantially preventing moisture from escaping said sealed chamber for an extended period of time, thereby at least reducing moisture loss from said freezable consumable liquid and maintaining the stability of said freezable consumable liquid;
wherein said packaging is sufficiently flexible when frozen such that the frozen consumable liquid therein is consumable by opening one of said ends of said tubular body and exerting pressure from the opposed end to urge said frozen consumable liquid out of the open end of said tubular body.

2. The therapeutic freezer pop of claim 1, wherein said at least one moisture barrier layer is located between said intermediate and outer layers.

3. The therapeutic freezer pop of claim 1, wherein said at least one of said moisture barrier layers overlays the outside surface of said at least one outer layer.

4. The therapeutic freezer pop of claim 1, wherein said packaging has a water vapor transmission rate of less than 0.25 gms/100 inch²/24 hours at 100° F., 90% RH.

5. The therapeutic freezer pop of claim 1, wherein said at least one moisture barrier layer is comprised of a low moisture transmission material selected from the group consisting of low moisture transmission polymer films and metal foils.

6. The therapeutic freezer pop of claim 5, wherein the low moisture transmission polymer film is selected from the group consisting of polyvinylidene chloride and polychlorotrifluoroethylene.

7. The therapeutic freezer pop of claim 5, wherein the metal foil is aluminum foil.

8. The therapeutic freezer pop of claim 1, wherein said sealable material is an adhesive material.

9. The therapeutic freezer pop of claim 8, wherein said adhesive material is selected from the group consisting of pressure sealable adhesive materials, heat sealable adhesive materials, and combinations thereof.

10. The therapeutic freezer pop of claim 9, wherein said sealable adhesive material is low-density polyethylene-linear low-density polyethylene.

11. The therapeutic freezer pop of claim 1, wherein said sealable material is in the form of a sealable layer having a thickness of from 100 to 400 gauge.

12. The therapeutic freezer pop of claim 1, wherein said tear and puncture resistant material is selected from the group consisting of polyethylene terephthalate, and oriented polypropylene, and biaxial nylon.

13. The therapeutic freezer pop of claim 1, wherein said therapeutic agent is selected from the group consisting of pharmaceuticals, medicaments, nutritional agents, vitamins, neutraceuticals, and the like.

14. The therapeutic freezer pop of claim 1, wherein:
said inner layer is linear low-density polyethylene or low-density polyethylene-linear low-density polyethylene with a thickness of 100 gauge to 400 gauge;
said outer layer is PET with a thickness of 36-200 gauge;
said intermediate layer is low-density polyethylene with a thickness of 9 to 12 lb/m² and provides a structural bond between said inner and outer layers; and
said moisture barrier layer is polyvinylidene chloride.

15. The therapeutic freezer pop of claim 1, wherein said packaging is formed from materials that are substantially transparent.

16. The therapeutic freezer pop of claim 1, wherein said freezable consumable liquid is quiescently frozen.

17. The therapeutic freezer pop of claim 16, wherein said frozen consumable liquid is fast dissolving.

18. The therapeutic freezer pop of claim 1, wherein said frozen consumable liquid is fast dissolving.

19. The therapeutic freezer pop of claim 17, wherein said frozen consumable liquid dissolves in less than 30 seconds after placing said frozen consumable liquid in an oral cavity.
